(19) United States
(12) Patent Application Publication
(10) Pub. No.: US 2022/0036417 A1
(43) Pub. Date: Feb. 3, 2022

(54) COMMON MARKETPLACE PLATFORM FOR TECHNOLOGY CREATORS, BUYERS, AND EXPERT PROFESSIONALS

(71) Applicant: FYRII.AI, Cupertino, CA (US)

(72) Inventors: Venkatesh Subramanian, Cupertino, CA (US); Padma Subramanian, Cupertino, CA (US); Sidharth Mishra, Cupertino, CA (US)

(21) Appl. No.: 17/386,720

(22) Filed: Jul. 28, 2021

Related U.S. Application Data
(60) Provisional application No. 63/057,949, filed on Jul. 29, 2020.

(51) Int. Cl. G06Q 30/06; G06N 3/02

(52) U.S. Cl. CPC G06Q 30/0609; G06N 3/02; G06Q 30/0613; G06Q 30/0605

(57) ABSTRACT

The present invention relates to a system (100) and a method of a common market place for technology creators. The system (100) of the present invention includes a technology creator computing device (102), an enterprise buyer computing device (104), an expert agent computing device (106), and a cloud server (108). The cloud server (108) executes computer-readable instruction that provides a common digital platform for the technology creators, the enterprise buyers, and the expert agents to interact with each through the technology creator computing device (102), the enterprise buyer computing device (104) and the expert agent computing device (106) respectively. Further, the technology creators, the enterprise buyers and the expert agents create their profile on the common digital. Herein, the cloud server (108) executes computer-readable instructions to help the technology creators to search for the enterprise buyers and the expert agents based on the technology set of the technology creators.

### FIELD OF INVENTION

The present invention relates to a common marketplace system, and method for technology creators and buyers, and more specifically relates to an artificial intelligence-based matching platform that connects technology creators with buyers and expert professionals for monetizing the technology.

Technology is being developed at exponential rates. Human intelligence is increasing linearly but technologies are expanding exponentially. Data scientists and artificial intelligence are part of exponential technologies. Thus much technology has been created based on the different exponential technologies.

The problem is with the creator of these technologies is that they are unable to sell these technologies to consumers and also to get potential investors to expand business based on these technologies. Because it became difficult to make potential buyers understand these technologies. There is a huge knowledge gap.

Another problem with the technology creator they do not how to sell their product and services. The technology creators also have to struggle in operating a business efficiently.

There are several patent applications all around the world that are working on the selling of products and services. The patent application WO2015044706A1 discloses a Methods, systems, device, network, platform, and apparatus for enabling multi-model, multi networks/destinations, multi-functional, real-time, collaborative, visualize, unified, integrated and dynamic advertisements, marketing and e-commerce platform, identifying, matching, providing and managing actual and prospective customers and sales leads, and enabling user to make disclosure about and provide detail structures and unstructured information regarding what, where, when, how, why they want to purchase, going to purchase and already purchased one or more types of products and services and enabling to identifying, searching, matching, selecting, connecting, communicating, facilitating and managing actual and prospective customers.

Patent application US20120059731A1 discloses a method of brokering a relationship between buyers and sellers via electronic means by way of an intermediary facilitating this relationship. Potential buyers of goods or services relay their requirements and desired range of pricing for a good or service to an aggregator. A potential buyer's personal contact information is hidden from any seller that would be interested in selling a buyer the requested good or service. Sellers have the option of searching a list of willing buyers of goods or services or may have this list sent to them electronically. Additionally, the requirements of buyers may be proactively used to search seller websites or databases via a web crawler. A brokerage fee to an aggregator is all that is required for a seller to gain access to a buyer via proxy. This method does not bind buyers to sellers. It allows a buyer to set a pre-determined price range based on his requirements for a good or service and a seller to make an initial connection with a buyer based on these needs. Should a buyer transact with the seller, the buyer is incentivized to report the sale to the intermediary such that an additional transaction fee may be charged by the aggregator.

The exiting invention provides only provide a platform to sell. But the technology creator needs the other expert opinion on sales and market to make their product appealing to the potential buyer. This is within the aforementioned context that a need for the present invention has arisen. Thus, there is a need to address one or more of the foregoing disadvantages of conventional systems and methods, and the present invention meets this need.

### SUMMARY OF THE INVENTION

The present invention relates to a system and method of a common market place for technology creators. The system of the present invention includes a technology creator computing device, an enterprise buyer computing device, an expert agent computing device, and a cloud server. Technology creators use the technology creator computing device. Enterprise buyers use the enterprise buyer computing device. Expert agents use the expert agent computing device. In an embodiment, the technology creator computing device, the enterprise buyer computing device, and the expert agent computing device are selected form a desktop, a Smartphone, a tablet, and a laptop. The cloud server executes computer-readable instruction that provides a common digital platform for the technology creators, the enterprise buyers, and the expert agents interact with each other through the technology creator computing device, the enterprise buyer computing device, and the expert agent computing device respectively. Further, the technology creators, the enterprise buyers, and the expert agents create their profile on the common digital platform through the technology creator computing device, the enterprise buyer computing device, and the expert agent computing device respectively. Herein, the cloud server executes computer-readable instructions to help the technology creators to search for the enterprise buyers and expert agents based on the technology set of the technology creators.

In an embodiment, the cloud server executes a computer-readable instruction based on a text classification and relationship algorithms based that use recurrent neural network models to classify attribute of the expert agents and then apply text classification and relationship algorithms while matching expert agents with requests from the enterprise buyers and the technology creators. Further, the recurrent neural network models are trained using the resume sample to recognize the attribute of the expert agents.

In an embodiment, the cloud server executes computer-readable instructions based on personalization algorithms that use convolution neural networks to showcase the technology creators' products and similar products during a search by the enterprise buyers and also to showcase similar content recommendations during a content search by the enterprise buyers. Further, computer-readable instructions based on personalization algorithms provide personalized search results that correspond to the enterprise buyer.

In an embodiment, the cloud server executes different search algorithm selected from Bidirectional Encoder Representations from Transformers, for deeper context-based queries on the common digital platform.

Herein, the cloud server executes computer-readable instructions to help the enterprise buyers to search for the technology creators based on the technology set the enterprise buyers interested in. Herein, there are different expert agents in a different area of expertise that provide expertise helps to the technology creators and the enterprise buyers in selling and procurement of technology, product and services, and the expert agents also provide expert advice and training in the different domain through the common digital platform that is being created by the cloud server.

The main advantage of the present invention is that the present invention provides the common market place for the technology creators.

Yet another advantage of the present invention is that the present invention brings in expert agents into a neutral environment.

Yet another advantage of the present invention is that the present invention is able to bring in economies of scale and thereby allowing the technology creators to access top talent on a pay for performance model.

Yet another advantage of the present invention is that the present invention has intelligent search suggestions to make the search easier.

Further objectives, advantages, and features of the present invention will become apparent from the detailed description provided herein below, in which various embodiments of the disclosed invention are illustrated by way of example.

### BRIEF DESCRIPTION OF THE DRAWINGS

The accompanying drawings are incorporated in and constitute a part of this specification to provide a further understanding of the invention. The drawings illustrate one embodiment of the invention and together with the description, serve to explain the principles of the invention.

FIG. 1 illustrates the system of the present invention.

### DETAILED DESCRIPTION OF THE INVENTION

### Definition

The terms “a” or “an”, as used herein, are defined as one or as more than one. The term “plurality”, as used herein, is defined as two as or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Term “comprising” is not intended to limit inventions to only claiming the present invention with such comprising language. Any invention using the term comprising could be separated into one or more claims using “consisting” or “consisting of” claim language and is so intended. The term “comprising” is used interchangeably used by the terms “having” or “containing”.

Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps, or acts are in some way inherently mutually exclusive.

As used herein, the term “one or more” generally refers to, but not limited to, singular as well as the plural form of the term.

The drawings featured in the figures are to illustrate certain convenient embodiments of the present invention and are not to be considered as a limitation to that. The term “means” preceding a present participle of operation indicates the desired function for which there is one or more embodiments, i.e., one or more methods, devices, or apparatuses for achieving the desired function and that one skilled in the art could select from these or their equivalent because of the disclosure herein and use of the term “means” is not intended to be limiting.

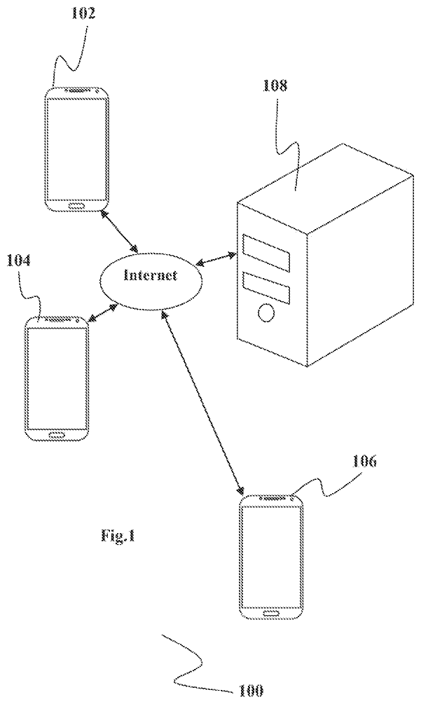

FIG. 1 illustrates a system (100) common market place for technology creators. The system (100) of the present invention includes a technology creator computing device (102), an enterprise buyer computing device (104), an expert agent computing device (106), and a cloud server (108). The cloud server (108) executes computer-readable instruction that provides a common digital platform for the technology creators, the enterprise buyers, and the expert agents to interact with each through the technology creator computing device (102), the enterprise buyer computing device (104) and the expert agent computing device (106) respectively.

The present invention relates to a system and method of a common market place for technology creators. The system of the present invention includes a technology creator computing device, an enterprise buyer computing device, an expert agent computing device, and a cloud server. Technology creators use the technology creator computing device. Enterprise buyers use the enterprise buyer computing device. Expert agents use the expert agent computing device. In an embodiment, the technology creator computing device, the enterprise buyer computing device, and the expert agent computing device are selected form a desktop, a smartphone, a tablet, and a laptop. The cloud server executes computer-readable instruction that provides a common digital platform for the technology creators, the enterprise buyers, and the expert agents interact with each other through the technology creator computing device, the enterprise buyer computing device, and the expert agent computing device respectively. Further, the technology creators, the enterprise buyers, and the expert agents create their profile on the common digital platform through the technology creator computing device, the enterprise buyer computing device, and the expert agent computing device respectively. Herein, the cloud server executes computer-readable instructions to help the technology creators to search for the enterprise buyers and expert agents based on the technology set of the technology creators.

In an embodiment, the cloud server executes computer-readable instructions based on a text classification and relationship algorithms that use recurrent neural network models to classify attribute of the expert agents and then apply text classification and relationship algorithms while matching expert agents with requests from the enterprise buyers and the technology creators. Further, the recurrent neural network models are trained using the resume sample to recognize the attribute of the expert agents.

In an embodiment, the cloud server executes computer-readable instructions based on personalization algorithms that use convolution neural networks to showcase the technology creators' products and similar products during a search by the enterprise buyers and also to showcase similar content recommendations during content search by the enterprise buyers. Further, computer-readable instructions based on personalization algorithms provides personalized search results that corresponds to the enterprise buyer.

In an embodiment, the cloud server executes different search algorithm selected from a Bidirectional Encoder Representations from Transformers, for deeper context based queries on the common digital platform.

Herein, the cloud server executes computer-readable instructions to help the enterprise buyers to search for the technology creators based on the technology set the enterprise buyers interested in. Herein, there are different expert agents in different area of expertise that provide expertise helps to the technology creators and the enterprise buyers in selling and procurement of technology product and services, and the expert agents also provide expert advice and training in different domain through the common digital platform that is being created by the cloud server.

In an embodiment, the present invention relates to a system and method of common market place for technology creator. The system of the present invention includes one or more technology creator computing devices, one or more enterprise buyer computing devices, one or more expert agent computing devices, and one or more cloud servers. Technology creators use the one or more technology creator computing devices. Enterprise buyers use the one or more enterprise buyer computing devices. Expert agents use the one or more expert agent computing devices. In an embodiment, the one or more technology creator computing devices, the one or more enterprise buyer computing devices and the one or more expert agent computing devices are selected form a desktop, a smart phone, a tablet, and a laptop. The one or more cloud servers executes computer-readable instruction that provides a common digital platform for the technology creators, the enterprise buyers and the expert agents interact with each other through the one or more technology creator computing devices, the one or more enterprise buyer computing devices and the one or more expert agent computing devices respectively. Further, the technology creators, the enterprise buyers and the expert agents create their profile on the common digital platform through the one or more technology creator computing devices, the one or more enterprise buyer computing devices and the one or more expert agent computing devices respectively. Herein, the one or more cloud servers executes computer-readable instructions to help the technology creators to search for the enterprise buyers and the expert agents based on the technology set of the technology creators.

In an embodiment, the one or more cloud servers executes computer-readable instructions based on an text classification and relationship algorithms that use recurrent neural network models to classify attribute of the expert agents and then apply text classification and relationship algorithms while matching expert agents with requests from the enterprise buyers and the technology creators. Further, the recurrent neural network models are trained using the resume sample to recognize the attribute of the expert agents.

In an embodiment, the one or more cloud servers executes computer-readable instructions based on personalization algorithms that use convolution neural networks to showcase the technology creators products and similar products during a search by the enterprise buyers and also to showcase similar content recommendations during content search by the enterprise buyers. Further, computer-readable instructions based on personalization algorithms provides personalized search results that corresponds to the enterprise buyer.

In an embodiment, the one or more cloud servers executes different search algorithm selected from a Bidirectional Encoder Representations from Transformers, for deeper context based queries on the common digital platform.

Herein, the one or more cloud servers executes computer-readable instructions to help the enterprise buyers to search for the technology creators based on the technology set the enterprise buyers interested in. Herein, there are different expert agents in different area of expertise that provide expertise helps to the technology creators and the enterprise buyers in selling and procurement of technology product and services, and the expert agents also provide expert advice and training in different domain through the common digital platform that is being created by the one or more cloud servers.

In an embodiment, present invention relates to a method of common market place for technology creator, the method includes:

a method of creation of a common digital platform, the method having:
a cloud server executes computer-readable instruction that provides a common digital platform for technology creators, enterprise buyers sand expert agents to interact with each through technology creator computing device, an enterprise buyer computing device and an expert agent computing device respectively; and
Further, the technology creators, the enterprise buyers and the expert agents create their profile on the common digital platform through the technology creator computing device, the enterprise buyer computing device and the expert agent computing device respectively.

Herein, in the profile of the technology creators, the technology creators upload their technology product and service details to be displayed on the profile of the technology creators and that is accessible to the enterprise buyers on the enterprise buyer computing device and the expert agents on the expert agent computing device.

Herein, the expert agent's profiles are created on the common digital platform based on the expert agent's skill set.

A method of selling technology product and service on the common digital platform, the method having:
the technology creators upload their technology product and service details on the cloud server through the technology creator computing device, to be displayed on the profile of the technology creators;
the technology creators send request, through the technology creator computing device, to the cloud server that executes computer-readable instruction to search for the expert agents based on the technology product and service details of the technology creators;
the cloud server executes computer-readable instructions based on an text classification and relationship algorithms that uses recurrent neural network models to classify attribute of the expert agents and then apply text classification and relationship algorithms while matching expert agents with requests from the technology creators;
the expert agents get notification of the new technology creators on the expert agent computing device;
the expert agents provide statement of work and fee to the technology creators through the expert agent computing device;
after being accepted by the technology creators, the expert agents provide expertise help to market and sell the technology product and service details of the technology creators to the enterprise buyers, the expert agents also provide expert advice and training in different domain through the common digital platform that is being created by the cloud server.
Herein, there is a contact of the expert agents on the profile of the technology creators to get the procurement process started with the enterprise buyer.
Herein, the recurrent neural network models are trained using the resume sample to recognize the attribute of the expert agents.

A method of procurement by the enterprise buyer, the method having
the enterprise buyers send request, through the enterprise buyer computing device, to the cloud server that executes computer-readable instruction to search for the technology creator based on the technology set, the enterprise buyer interested in;
the cloud server executes Computer-readable instructions based on personalization algorithms that use convolution neural networks to showcase the technology creator products and similar products during a search by the enterprise buyers and also to showcase similar content, content recommendations during content search by the enterprise buyers and, further, computer-readable instructions based on personalization algorithms provides personalized search results that corresponds to the enterprise buyers;
the enterprise buyers browse the deep dive technology product and service details in the profile of the technology creators;
at least one cloud server executes computer-readable instruction to notify the enterprise buyers, on the one or more enterprise buyer computing device, to engage the expert agents that are hired by the technology creators;
further the expert agents get notification on the expert agent computing device when the enterprise buyers, selects the expert agents to engage;
further the enterprise buyers, and the enterprise buyers come together to complete the procurement process.

A method of participating community market place by the expert agents, the method having
the expert agents upload various kinds of content, on the cloud server, such as marketing, industry insights, training and development;
the expert agents price these contents on a per download pricing;
the expert agents schedule live stream training, learning or other live events and set the ticket price per event;
Users pay the ticket price through the payment module and enter to view this live stream content;
the expert agents run panel discussions and other useful forums on the community market place.

A method of advising by the expert agents, the method having
the enterprise buyers and the technology creator, and other parties request projects seeking advice from the expert agents in specific domain;
the cloud server executes computer-readable instructions based on an text classification and relationship algorithms that uses recurrent neural network models to classify attribute of the expert agents and then apply text classification and relationship algorithms while matching expert agents with requests;
the expert agents are paid for these advisory sessions.

In an embodiment, there are expert agent that are specialized in different domain selected from marketing, finance, sales, technology solution, industry expertise, business transformation, procurement, and legal.

In an embodiment, the expert agents are shared by the enterprise buyers and the technology creator thus the system is able to achieve economies of scale.

In an embodiment, present invention relates to a method of common market place for technology creator, the method includes:

A method of creation of a common digital platform, the method having:
one or more cloud servers executes computer-readable instruction that provides a common digital platform for technology creators, enterprise buyers sand expert agents to interact with each through one or more technology creator computing devices, one or more enterprise buyer computing devices and one or more expert agent computing devices respectively; and
Further, the technology creators, the enterprise buyers and the expert agents create their profile on the common digital platform through the one or more technology creator computing devices, the one or more enterprise buyer computing devices and the one or more expert agent computing devices respectively.

Herein, in the profile of the technology creators, the technology creators upload their technology product and service details to be displayed on the profile of the technology creators and that is accessible to the enterprise buyers on the one or more enterprise buyer computing devices and the expert agents on the one or more expert agent computing devices.

Herein, the expert agents' profiles are created on the common digital platform based on the expert agent's skill set.

A method of selling technology product and service on the common digital platform, the method having:
the technology creators upload their technology product and service details on the one or more cloud servers through the one or more technology creator computing devices, to be displayed on the profile of the technology creators;
the technology creators send request, through the one or more technology creator computing devices, to the one or more cloud servers that execute computer-readable instruction to search for the expert agents based on the technology product and service details of the technology creators;
the one or more cloud servers executes computer-readable instructions based on an text classification and relationship algorithms that uses recurrent neural network models to classify attribute of the expert agents and then apply text classification and relationship algorithms while matching expert agents with requests from the technology creators;
the expert agents get notification of the new technology creators on the one or more expert agent computing devices;
the expert agents provide statement of work and fee to the technology creators through the one or more expert agent computing devices;
after being accepted by the technology creators, the expert agents provide expertise help to market and sell the technology product and service details of the technology creators to the enterprise buyers, the expert agents also provide expert advice and training in different domain through the common digital platform that is being created by the one or more cloud servers.

Herein, there is a contact of the expert agents on the profile of the technology creators to get the procurement process started with the enterprise buyer.

Herein, the recurrent neural network models is trained using the resume sample to recognize the attribute of the expert agents.

A method of procurement by the enterprise buyer, the method having
the enterprise buyers send request, through the one or more enterprise buyer computing devices, to the one or more cloud servers that execute computer-readable instruction to search for the technology creator based on the technology set, the enterprise buyer interested in;
the one or more cloud servers executes Computer-readable instructions based on personalization algorithms that use convolution neural networks to showcase the technology creator products and similar products during a search by the enterprise buyers and also to showcase similar content, content recommendations during content search by the enterprise buyers and, further, computer-readable instructions based on personalization algorithms provides personalized search results that correspond to the enterprise buyers;
the enterprise buyers browse the deep dive technology product and service details in the profile of the technology creators;
at least one cloud server executes computer-readable instruction to notify the enterprise buyers, on the one or more enterprise buyer computing device, to engage the expert agents that are hired by the technology creators;
further the expert agents get notification on the one or more expert agent computing devices when the enterprise buyers, selects the expert agents to engage;
further the enterprise buyers, and the enterprise buyers come together to complete the procurement process.

A method of participating community market place by the expert agents, the method having
the expert agents upload various kinds of content, on the one or more cloud servers, such as marketing, industry insights, training and development;
the expert agents price these contents on a per download pricing;
the expert agents schedule live stream training, learning or other live events and set the ticket price per event;
Users pay the ticket price through the payment module and enter to view this live stream content;
the expert agents run panel discussions and other useful forums on the community market place.

A method of advising by the expert agents, the method having
the enterprise buyers and the technology creator, and other parties request projects seeking advice from the expert agents in specific domain;
the one or more cloud servers executes computer-readable instructions based on an text classification and relationship algorithms that uses recurrent neural network models to classify attribute of the expert agents and then apply text classification and relationship algorithms while matching expert agents with requests;
the expert agents are paid for these advisory sessions.

In an embodiment, there are expert agent that are specialized in different domain selected from marketing, finance, sales, technology solution, industry expertise, business transformation, procurement, and legal.

In an embodiment, the expert agents are shared by the enterprise buyers and the technology creator thus the system is able to achieve economies of scale.

In an embodiment, an at least one cloud server (108) executes computer-readable instruction that also provides a open innovation platform to the expert agents and the enterprise buyers to drive innovation, the open innovation platform having

a makers hub, the maker hub having
the expert agents showcase their industry expertise by creating and sharing the expert agents content on the maker hub of the open innovation platform through the at least one expert agent computing device (106),
the expert agents also use the maker hub to analyze new products, business architecture content of the technology creators and enterprise buyers,
the expert agents is also able to price their content while sharing their content on the maker hub of the open innovation platform,
the enterprise buyers also puts topic suggestions on the maker hub of the open innovation platform, that the expert agents pick up and submit contents, then the enterprise buyers approves the ones that meet the expert agents needs and pay for submited contents and also the expert agents publish submited contents on the maker
the enterprise buyers also pay for the expert agents to run research and publish the industry analysis reports selected from a vendor comparisons, industry trends, CXO care abouts etc; and

a developer hub, the developer hub having
solution pages that describe the products and solutions, solution pages are also linked to organization website pages,
Use cases and sample applications of the expert agents and the expert agents monetize them the expert agents,
both the enterprise buyers and the expert agents share product integrations, integration guides, evaluation notes on the developer hub of the open innovation platform,
there is a contact the expert button to be able to contact the expert agents to get help for integrations and do product evaluations,
the expert agents share business cases, ROI modeling and other content on the developer hub of the open innovation platform,
the expert agents share content related to product extensions and innovation on the developer hub of the open innovation platform,
there is an idea generator where the expert agents suggest new markets, business model transformation and other market extending ideas that is “owned” by the expert agents and the enterprise buyers “procure” the idea from the expert agents;

a method of adding the expert agent in Dev Hub, the method having
the enterprise buyers set the requirements for the expert agents on the open innovation platform, then the open innovation platform notifies the expert agents
the expert agents who accept the notification are also reviewed by the enterprise buyers and once accepted are included into the Dev Hub;

a method of engagement, the method having
a challenge based innovation engagement, the method having
   the enterprise buyers issues a challenge for innovation,
   the challenge appear within the Dev hub and the expert agents apply to pick up the challenge,
   the expert agents show a sample and prototype,
   the enterprise buyers then picks the expert agents who get some investment to further develop sample and prototype
a project based engagement,
a content based engagement

Further objectives, advantages, and features of the present invention will become apparent from the detailed description provided herein, in which various embodiments of the disclosed present invention are illustrated by way of example and appropriate reference to accompanying drawings. Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings.

We claim:

1. A system (100) and method of common market place for technology creator, the system (100) comprising:
an at least one technology creator computing device (102), technology creators use the at least one technology creator computing device (102);
an at least one enterprise buyer computing device (104), enterprise buyers use the at least one enterprise buyer computing device (104);
an at least one expert agent computing device (106), expert agents use the at least one expert agent computing device (106);
an at least one cloud server (108), the at least one cloud server (108) executes computer-readable instruction that provides a common digital platform for the technology creators, the enterprise buyers and the expert agents to interact with each through the at least one technology creator computing device (102), the at least one enterprise buyer computing device (104) and the at least one expert agent computing device (106) respectively, further, the technology creator, the enterprise buyers and the expert agents create their profile on the common digital platform through the at least one technology creator computing device (102), the at least one enterprise buyer computing device (104) and the at least one expert agent computing device (106) respectively;
wherein, the at least one cloud server (108) executes computer-readable instructions to help the technology creators to search for the enterprise buyers and the expert agents based on the technology set of the technology creators,
wherein, the at least one cloud server (108) executes computer-readable instructions to help the enterprise buyers to search for the technology creators based on the technology set the enterprise buyers interested in,
wherein, there are different expert agents in different area of expertise that provide expertise helps to the technology creators and the enterprise buyers in selling and procurement of technology product and services, and the expert agents also provide expert advice and training in different domain through the common digital platform that is being created by the at least one cloud server (102).

2. The system (100) as claimed in claim 1, wherein, the at least one cloud server (108) executes computer-readable instructions based on an text classification and relationship algorithms that uses recurrent neural network models to classify attribute of the expert agents and then apply text classification and relationship algorithms while matching expert agents with requests from the enterprise buyers and the technology creators, Further, the recurrent neural network models are trained using the resume sample to recognize the attribute of the expert agents.

3. The system (100) as claimed in claim 1, wherein, the at least one cloud server (108) executes computer-readable instructions based on personalization algorithms that use convolution neural networks to showcase the technology creators products and similar products during a search by the enterprise buyers and also to showcase similar content, content recommendations during content search by the enterprise buyers and, further, computer-readable instructions based on personalization algorithms provides personalized search results that corresponds to the enterprise buyer.

4. The system (100) as claimed in claim 1, wherein, the at least one cloud server (108) executes different search algorithm selected from a Bidirectional Encoder Representations from Transformers, for deeper context based queries on the common digital platform.

5. The system (100) as claimed in claim 1, wherein, the at least one technology creator computing device (102), the at least one enterprise buyer computing device (104) and the at least one expert agent computing device(106) are selected form a desktop, a smart phone, a tablet, and a laptop.

6. A method of common market place for technology creator, the method comprising:
a method of creation of a common digital platform, the method having:
an at least one cloud server (108) executes computer-readable instruction that provides a common digital platform for technology creators, enterprise buyers sand expert agents to interact with each through an at least one technology creator computing device (102), an at least one enterprise buyer computing device (104) and an at least one expert agent computing device (106) respectively, and
Further, the technology creators, the enterprise buyers and the expert agents create their profile on the common digital platform through the at least one technology creator computing device (102), the at least one enterprise buyer computing device (104) and the at least one expert agent computing device (106) respectively,
Wherein, in the profile of the technology creators, the technology creators upload their technology product and service details to be displayed on the profile of the technology creators and that is accessible to the enterprise buyers on the at least one enterprise buyer computing device (104) and the expert agents on the at least one expert agent computing device (106),
Wherein, the expert agent's profiles are created on the common digital platform based on the expert agent's skill set;
a method of selling technology product and service on the common digital platform, the method having:
the technology creators upload their technology product and service details on the at least one cloud server (108) through the at least one technology creator computing device (102), to be displayed on the profile of the technology creators,
the technology creators send request, through the at least one technology creator computing device (102), to the at least one cloud server (108) that executes computer-readable instruction to search for the expert agents based on the technology product and service details of the technology creators,
the at least one cloud server (108) executes computer-readable instructions based on an text classification and relationship algorithms that uses recurrent neural network models to classify attribute of the expert agents and then apply text classification and relationship algorithms while matching expert agents with requests from the technology creators,
the expert agents get notification of the new technology creators on the at least one expert agent computing device (106),
the expert agents provide statement of work and fee to the technology creators through the at least one expert agent computing device (106),
after being accepted by the technology creators, the expert agents provide expertise help to market and sell the technology product and service details of the technology creators to the enterprise buyers, the expert agents also provide expert advice and training in different domain through the common digital platform that is being created by the at least one cloud server (108),
wherein, there is a contact of the expert agents on the profile of the technology creators to get the procurement process started with the enterprise buyer,
wherein, the recurrent neural network models is trained using the resume sample to recognize the attribute of the expert agents;
a method of procurement by the enterprise buyer, the method having
the enterprise buyers send request, through the at least one enterprise buyer computing device (104), to the at least one cloud server (108) that executes computer-readable instruction to search for the technology creator based on the technology set, the enterprise buyer interested in,
the at least one cloud server (108) executes Computer-readable instructions based on personalization algorithms that use convolution neural networks to showcase the technology creator products and similar products during a search by the enterprise buyers and also to showcase similar content, content recommendations during content search by the enterprise buyers and, further, computer-readable instructions based on personalization algorithms provides personalized search results that correspond to the enterprise buyers,
the enterprise buyers browse the deep dive technology product and service details in the profile of the technology creators,
at least one cloud server (108) executes computer-readable instruction to notify the enterprise buyers, on the at least one enterprise buyers computing device (104), to engage the expert agents that is hired by the technology creators,
further the expert agents get notification on the at least one expert agent computing device (106) when the enterprise buyers, selects the expert agents to engage,
further the enterprise buyers, and the enterprise buyers come together to complete the procurement process;
a method of participating community market place by the expert agents, the method having
the expert agents upload various kinds of content, on the at least one cloud server (108), such as marketing, industry insights, training and development,
the expert agents price these contents on a per download pricing,
the expert agents schedule live stream training, learning or other live events and set the ticket price per event,
Users pay the ticket price through the payment module and enter to view this live stream content,
the expert agents run panel discussions and other useful forums on the community market place;
a method of advising by the expert agents, the method having
the enterprise buyers and the technology creator, and other parties request projects seeking advice from the expert agents in specific domain.
the at least one cloud server (108) executes computer-readable instructions based on an text classification and relationship algorithms that uses recurrent neural network models to classify attribute of the expert agents and then apply text classification and relationship algorithms while matching expert agents with requests,
the expert agents are paid for these advisory sessions.
wherein, the expert agents are specialized in a different domain selected from marketing, finance, sales, technology solution, industry expertise, business transformation, procurement, and legal,
wherein, the expert agents are shared by the enterprise buyers and the technology creator thus the system (100) is able to achieve economies of scale.

7. The method as claimed in claim 6, wherein an at least one cloud server (108) executes computer-readable instruction that also provides a open innovation platform to the expert agents and the enterprise buyers to drive innovation, the open innovation platform comprising:
a makers hub, the maker hub having
the expert agents showcase their industry expertise by creating and sharing the expert agents content on the maker hub of the open innovation platform through the at least one expert agent computing device (106),
the expert agents also use the maker hub to analyze new products, business architecture content of the technology creators and enterprise buyers,
the expert agents is also able to price their content while sharing their content on the maker hub of the open innovation platform,
the enterprise buyers also puts topic suggestions on the maker hub of the open innovation platform, that the expert agents pick up and submit contents, then the enterprise buyers approves the ones that meet the expert agents needs and pay for submited contents and also the expert agents publish submited contents on the maker
the enterprise buyers also pay for the expert agents to run research and publish the industry analysis reports selected from a vendor comparisons, industry trends, CXO care abouts etc; and
a developer hub, the developer hub having
solution pages that describe the products and solutions, solution pages are also linked to organization website pages,
Use cases and sample applications of the expert agents and the expert agents monetize them the expert agents,
both the enterprise buyers and the expert agents share product integrations, integration guides, evaluation notes on the developer hub of the open innovation platform,
there is a contact the expert button to be able to contact the expert agents to get help for integrations and do product evaluations,
the expert agents share business cases, ROI modeling and other content on the developer hub of the open innovation platform,
the expert agents share content related to product extensions and innovation on the developer hub of the open innovation platform,
there is an idea generator where the expert agents suggest new markets, business model transformation and other market extending ideas that is “owned” by the expert agents and the enterprise buyers “procure” the idea from the expert agents;
a method of adding the expert agent in Dev Hub, the method having
the enterprise buyers set the requirements for the expert agents on the open innovation platform, then the open innovation platform notifies the expert agents the expert agents who accept the notification are also reviewed by the enterprise buyers and once accepted are included into the Dev Hub;
a method of engagement, the method having
a challenge based innovation engagement, the method having
the enterprise buyers issues a challenge for innovation,
the challenge appear within the Dev hub and the expert agents apply to pick up the challenge,
the expert agents show a sample and prototype,
the enterprise buyers then picks the expert agents who get some investment to further develop sample and prototype
a project based engagement,
a content based engagement
